(19) United States
(12) Patent Application Publication
(10) Pub. No.: US 2017/0274414 A1
(43) Pub. Date: Sep. 28, 2017

(54) APPLICATION DEVICE FOR APPLYING GEL-LIKE AND/OR PASTE-LIKE COMPOSITIONS AND APPLICATION UNIT FOR AN APPLICATION DEVICE OF THIS TYPE

(71) Applicant: SIKA TECHNOLOGY AG, Baar (CH)

(72) Inventors: Michael RUHSTALLER, Galgenen (CH); Christian SCHULTHEISS, Pfäffikon (CH); Manuel BUCK, Gebenstorf (CH)

(73) Assignee: SIKA TECHNOLOGY AG, Baar (CH)

(21) Appl. No.: 15/505,808

(22) PCT Filed: Sep. 1, 2015
(86) PCT No.: PCT/EP2015/069892

§ 371 Date: Feb. 22, 2017

(30) Foreign Application Priority Data
Sep. 2, 2014 (EP) 14183246.9

(51) Int. Cl. B05C 17/005

(52) U.S. Cl. CPC B05C 17/00509; B05C 17/00513; B05C 17/00553

(57) ABSTRACT

The invention relates to an application unit for an application device, in particular an application gun for applying gel-like and/or paste-like compositions, having an output unit for dispensing the compositions, a connection element, such as a cover, for connecting the output unit to the main body of the application device, and a closure element, wherein the closure element is rotatable around an axis of rotation with respect to the connection element and the output unit for fastening the output unit on the connection element and for detaching the output unit from the connection element, wherein a lifting unit is formed and arranged in such a way that the output unit is lifted by a rotation of the closure element.

### TECHNICAL FIELD

The present invention relates to an application device, in particular an application gun, for applying gel-like and/or paste-like compositions and an application unit for such an application device.

### PRIOR ART

Application devices for applying gel-like and/or paste-like compositions are already known from the prior art. For example, EP 2 606 987 A1 discloses an application device in which a connection element is provided at a front end of a device housing. A dispensing unit with a mixer is fitted to this connection element. In this instance, the connection element and dispensing element (for dispensing the composition) are fixed to each other by means of a closure element (retaining ring).

The dispensing unit of such an application device generally has to be removed from the device housing and connected to the device housing again at regular intervals. In this context, it has been found that the removal of the dispensing unit is comparatively complex and troublesome.

US 2010/0102088 A1 describes an applicator having a cartridge which has two containers for components which are intended to be mixed. A mixer is connected to the cartridge by means of a catch connection. Ramps enable the mixer to be lifted relative to the cartridge by means of rotation. On the whole, the closure mechanism of US 2010/0102088 A1, in which, on the one hand, a movement to produce the catch connection and, on the other hand, a rotation movement to raise the mixer take place, is perceived to be complex.

WO 2006/005213 A1 describes a dispensing device for single use, having a multi-component cartridge with a closure and a mixer. By rotating a threaded ring, a valve mechanism is opened. The valve mechanism comprises a closure component which is engaged in a mixer housing. However, such a valve mechanism does not simplify (or does not enable) the removal of a dispensing unit from a main body.

EP 2 497 721 A1 describes a dispensing device for mixing and dispensing multi-component masses. A mixer housing is secured by means of a rotation cap. Furthermore, by means of a rotation of the rotation cap, the mixer housing can be moved away from the cartridge so that dispensing openings are opened and the dispensing of the components can be carried out. In this instance, therefore, a valve function which does not simplify removal of a dispensing unit from a main body is also primarily involved.

WO 2012/055926 A1 discloses a mixer which can be rotated relative to a connection element. However, such a (two-part) solution is not perceived to be very practicable in terms of handling.

An object of the present invention is therefore to provide an application device, in particular an application gun, for applying gel-like and/or paste-like compositions and an application unit for such an application device in which the removal of the dispensing unit is simplified and facilitated with respect to the prior art.

### STATEMENT OF INVENTION

This object is achieved according to the invention by an application unit as claimed in claim 1.

In particular the object is achieved by an application unit for an application device, in particular an application gun, for applying gel-like and/or paste-like compositions (such as, for example, adhesives and/or sealants), comprising a dispensing unit for dispensing the composition, a connection element, in particular cover, for connecting the dispensing unit to an application device main body and a closure element, wherein the closure element can be rotated about a rotation axis with respect to the connection element and the dispensing unit in order to secure the dispensing unit to the connection element and to release the dispensing unit from the connection element, wherein a lifting device is provided, constructed and arranged in such a manner that the dispensing unit is lifted by rotating the closure element (in order to release the dispensing unit).

A core notion of the invention involves using a rotation of the closure element in such a synergistic manner that, as a result of the rotation (in order to release the fixing between the connection element and dispensing element), the dispensing unit is raised. In this instance, the closure element rotates both with respect to the connection element and with respect to the dispensing unit. At least occasionally (preferably during the entire rotation operation), the dispensing unit and connection element are not rotated with respect to each other. Whilst the closure element carries out a rotation, the dispensing unit moves as a result of the lifting device in a translational manner away from the connection element. This forced translation movement leads to the dispensing unit being raised with respect to the connection element and thereby being able to be more readily removed (in particular, retention forces can be more readily overcome as a result of the fitting of the dispensing unit in the connection element).

The closure element, dispensing unit and connection element are in particular constructed as three separate components, which can in particular be rotated and/or moved in translation with respect to each other. Each of these components can therefore be moved in a rotational and/or translational manner with respect to each of the other two components. In particular there is provision for all three components to be able to be removed from each other (without destroying one of the three components or a permanent connection between the components). According to the invention, as a result of a rotation, there is therefore produced a lifting of the dispensing unit so that it can be released (can be removed) with respect to the connection element. The dispensing unit can thus be removed (preferably by hand) in particular when the lifting operation has been completed, that is to say, when a temporary end position of the dispensing unit (in a maximum raised state) is present. On the whole, it is thus not a case of proposing a type of valve mechanism in order to open dispensing openings, for which the prior art already offers solutions, but instead of providing a mechanism which in a simple manner enables (complete) removal of the dispensing unit, that is to say, there is also no longer an indirect connection between the dispensing unit and the connection element.

Gel-like and/or paste-like compositions may in particular be adhesives or sealants. It is conceivable in connection with adhesives in particular that they are in this instance ready adhesives or accelerated one-component adhesives, to which an accelerator or booster is added for more rapid hardening, or two-component adhesives. It is possible to use as sealants, for example, silicone sealants or the like or sealants based on silicone which are used, for example, in the field of sealing joints.

In this case, a gel-like composition has in particular a gel-like consistency. A gel is generally defined as a finely dispersed system comprising at least one solid and one fluid phase. The solid phase forms in this instance a sponge-like, three-dimensional network whose pores are filled by a fluid.

A paste-like composition has in particular a paste-like consistency, that is to say, a consistency similar to a paste (that is to say, a solid/fluid admixture, for example, suspension, having a preferably high content of solids) and has in particular structurally viscous properties.

The term “dispensing unit” is intended in particular to be understood to be a unit which has an opening from which the composition can be discharged. In a specific embodiment, the dispensing unit comprises in particular a mixer unit. The dispensing unit may have a nozzle element via the discharge opening of which the composition can be discharged. The basic structure and function of a dispensing unit can be derived from EP 2 606 987 A1 (the dispensing unit is described as a “mixer” therein). An application device main body may also be constructed with respect to the basic structure and function thereof as described in EP 2 606 987 A1.

The “lifting device” according to the invention is a structure which converts a rotation movement (of the closure element) at least partially into a translation movement (of the dispensing unit). The corresponding translation movement of the dispensing unit does not (necessarily) have to be carried out in an upward direction, but instead is generally carried out in a direction which faces away from the application device main body.

In a specific embodiment, the closure element and connection element form a bayonet closure in order to secure the dispensing unit to the connection element. Preferably, the lifting device may be at least partially formed by the bayonet closure. As a result of a bayonet closure, a releasable securing can be produced in a simple manner. If the bayonet closure still partially forms the lifting device, in a synergistic manner with a simple structure a dual functionality is produced, which significantly reduces both the production complexity and the complexity during use of the application device.

In a preferred embodiment, the lifting device has a closure element stop and a dispensing unit stop, wherein the closure element stop and the dispensing unit stop, when the closure element is rotated, come into sliding contact in such a manner that the dispensing unit is lifted as a result of the rotation of the closure element. As a result of such a development, the conversion from a rotation movement into a translation movement is carried out in a particularly simple manner. This facilitates the handling of the application device.

Preferably, the closure element stop is a component of the bayonet closure. The structure of the application device or the application unit is thereby also simplified so that production costs can be reduced and nonetheless a reliable functioning is ensured.

Alternatively or additionally, a surface normal of the closure element stop and/or the dispensing unit stop may extend parallel to the rotation axis. Particularly efficient lifting of the dispensing unit is thereby enabled.

Alternatively or additionally, the closure element stop may be provided on a peripheral face, in particular an inner peripheral face, of the closure element. Alternatively or additionally, the dispensing unit stop may be provided on a peripheral face, in particular an outer peripheral face, of the dispensing unit. Both stops can thereby be brought into engagement with each other in a particularly simple manner, which facilitates the handling of the application device.

Preferably, the closure element stop and/or the dispensing unit stop is/are defined by a side face of a rib. Alternatively or additionally, the closure element stop and/or the dispensing unit stop may be defined by a side face, in particular a lower side, of a wing element. In a specific embodiment, the closure element stop is defined by a side face of a rib and the dispensing unit stop by a side face (lower side) of a wing element. During a rotation, the side face (lower side) of the wing element slides along the rib and is lifted by the rib which is rotating, on the one hand, and moving in a translational manner, on the other hand. Particularly simple removal of the dispensing unit is thereby achieved.

In a preferred embodiment, the dispensing unit has at least one, in particular radially outwardly directed, wing element (in particular the above-described wing element), wherein the connection element has a corresponding recess for receiving the wing element. In particular when the dispensing unit is connected to the connection element (that is to say, for example, during the use of the application device), the wing element is received by the recess of the connection element. If the closure element is now rotated (in order to remove the dispensing unit), the wing element is displaced in a translational manner inside the recess (away from the application device main body). As a result of the recesses, on the one hand, a positioning of the dispensing unit is simplified. In particular, a position of the dispensing unit is also stabilized (even when, in the fixed position of the dispensing unit, it is retained in a rotationally secure manner by means of a shoulder element inside the application device main body). Overall, the handling is further simplified. In principle, the connection element may also conversely (in an alternative embodiment) have at least one (in particular radially inwardly directed) wing element and the dispensing unit may have a corresponding recess for receiving the wing element.

In a preferred embodiment of the application unit, the dispensing unit has a mixer unit. Alternatively or additionally, a nozzle element may be provided.

In a development, the bayonet closure may have an inclined introduction member which is formed on the closure element and which, when the dispensing unit is secured, runs against a (radially outwardly protruding) pin (generally a projection) of the connection element. Alternatively or additionally, the bayonet closure may have on the connection element an inclined connection element introduction member which, when the dispensing unit is released, runs against a projection of the closure element. Such a structure facilitates the removal of the dispensing unit.

In an alternative embodiment, the closure element and connection element form a screw closure in order to secure the dispensing unit to the connection element. For example, the closure element may have for this purpose an inner thread and the connection element may have a corresponding outer thread (or vice versa). Such a screw closure is preferably provided as an alternative (or in addition) to the bayonet closure. All the remaining components (individually or in combination), in particular an associated lifting device (for example, wing element) may be constructed as described above, in particular as in connection with the bayonet closure. Such a screw closure is simple to produce and operate. The closure element may be constructed as a (screw) closure ring.

The above-mentioned object is further achieved in particular by an application device, preferably an application gun, comprising an application unit of the type described above, and an application device main member.

The above-mentioned object is further independently achieved by the use of an application unit of the type described above for an application device, in particular an application gun, for applying gel-like and/or paste-like compositions (such as, for example, adhesives and/or sealants).

### BRIEF DESCRIPTION OF THE DRAWINGS

An embodiment of the invention is explained in greater detail below with reference to the drawings.

In the drawings:

FIG. 1 is an oblique schematic view of an application device according to the invention;

FIG. 2 is an oblique view of the application device according to FIG. 1 without any closure element;

FIG. 3 is an oblique schematic view of a closure element;

FIG. 4 is an oblique view of a dispensing unit;

FIG. 5 is an oblique schematic view of a connection element;

FIG. 6 is a side view of the connection element according to FIG. 5 with dotted portions of the dispensing unit according to FIG. 4 and the closure element according to FIG. 3;

FIG. 7 is an illustration similar to FIG. 6 after a rotation of the closure element according to FIG. 3 with respect to the connection element according to FIG. 5 and the dispensing unit according to FIG. 4; and

FIG. 8 is an illustration similar to FIGS. 6 and 7 after a further rotation of the closure element.

Only the elements which are significant for direct understanding of the invention are shown.

### METHOD FOR IMPLEMENTING THE INVENTION

FIG. 1 shows an application unit for an application device, in particular an application gun, for applying gel-like and/or paste-like compositions. The application unit comprises a dispensing unit 10, a closure element 11 and a connection element 12.

The connection element 12 is constructed as a cover element and terminates an application device main body (not shown) at the end thereof. The closure element 11 serves to secure the dispensing unit 10 to the connection element 12. The closure element 11 is constructed as an annular member and has on an outer peripheral face 13 axially extending projections 14 which facilitate a rotation of the closure element 11 when the application device is operated.

FIG. 2 corresponds to FIG. 1, wherein the closure element 11 has been omitted. It can thereby be seen that the dispensing unit 10 is received in the assembled state in a cylindrical member 15 of the connection element 12. Specifically, three (the number may also be smaller or larger) wings 16 are provided on the dispensing unit 10, wherein the wings 16 (in the assembly position) are arranged inside recesses 17 of the connection element 12. In principle, the dispensing unit 10, as illustrated in FIG. 2, could be removed from the connection element 12 by raising the dispensing unit. To this end, however, the (not inconsiderable) retention force of a shoulder element (not shown in the Figures) on which the dispensing unit is arranged inside the application device has to be overcome.

FIG. 2 further shows that the connection element 12 (on the cylindrical member 15) has a pin 18 and an inclined introduction member 19. The inclined introduction member 19 is in this instance defined by an (upper) peripheral edge 20 of the cylindrical member 15. The pin 18 is located on an outer peripheral face 21 of the connection element 12 or the cylindrical member 15.

The pin 18 is a component of a bayonet closure, the inclined introduction member 19 is a component of a lifting device in order to lift the dispensing unit 10 (via the wing 16 thereof) which is shown in the following Figures.

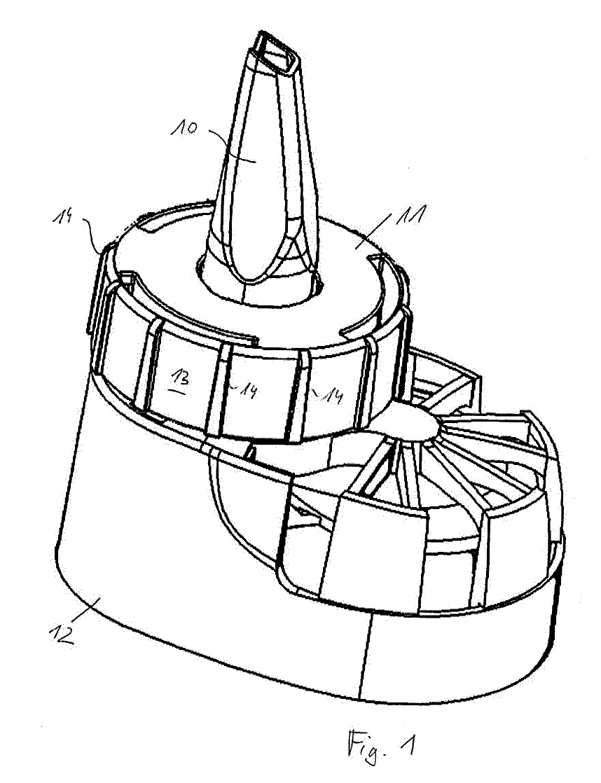

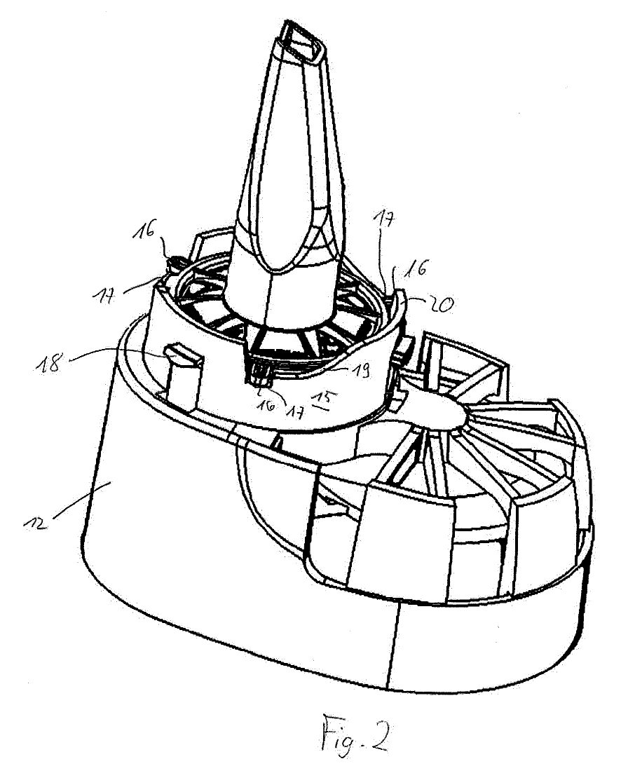

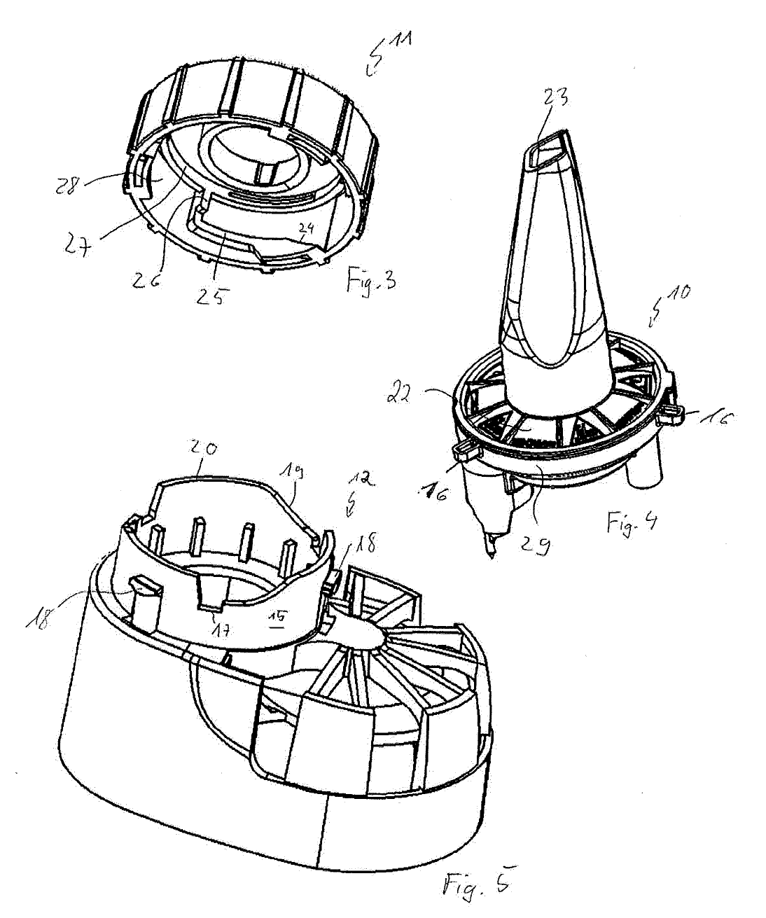

FIGS. 3 to 5 are oblique views of the elements dispensing unit 10, closure element 11 and connection element 12. FIG. 4 shows that the dispensing unit 10 has a mixer unit 22 and a discharge nozzle 23.

The function of the invention is explained below with particular reference to FIGS. 3 to 5 and FIGS. 6 to 8. FIGS. 6 to 8 are each a side view of the connection element 12. There is further illustrated with dotted lines: an inclined introduction member 24 of the closure element 11 (see also FIG. 3), a rib 25 of the connection element 11 (see also FIG. 3) and a projection 26 of the connection element 11 (see also FIG. 3) and one of the three wings 16 (see also FIG. 4) of the dispensing unit 10. In this instance, it should be noted that the elements shown with dotted lines in FIGS. 6 to 8 are illustrated in a highly schematic manner.

On the whole, it should be noted that the (mutually corresponding) elements with by the reference numerals 15, 16, 17, 19, 18, 24, 25 and 26 may be each provided three times. Another number is possible (for example, one, two or more than four). However, there is preferably provision for these elements to be constructed at least three times in order to enable a stable and reliable rotation of the closure element 11 or a stable and reliable securing of the dispensing unit 10. The triple construction (also shown in the Figures) is particularly preferred, wherein in particular the respective elements are arranged in a Mercedes-star-like configuration.

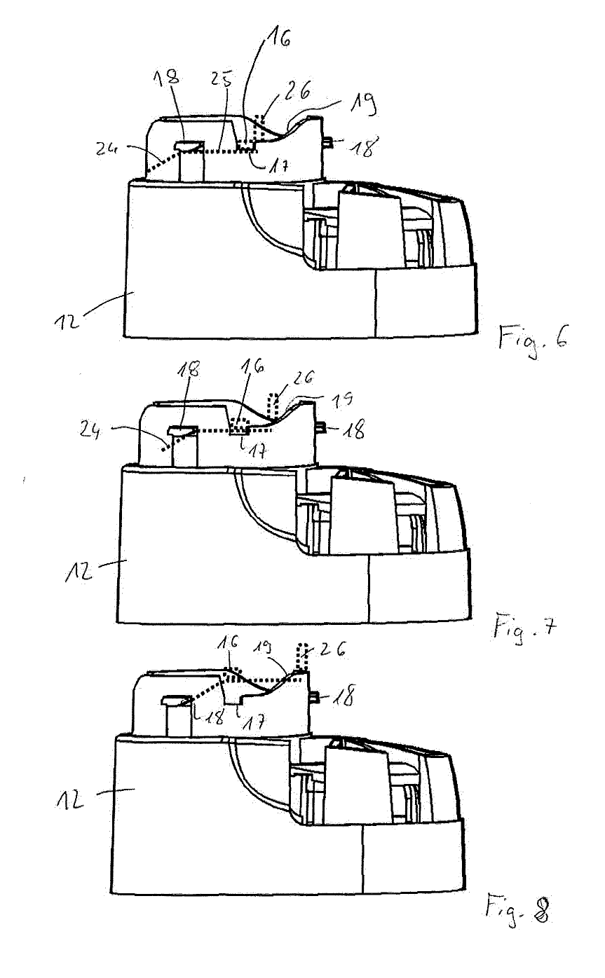

FIG. 6 shows a starting position of the application unit. This position is assumed when the dispensing unit 10 is connected to the connection element 12 via the closure element 11 (so that the application unit or the application device can be used). If the closure element 11 is now rotated (in FIGS. 3 to 8 in a counter-clockwise direction when viewed from above), the projection 26 runs against the inclined introduction member 19 so that the closure element 11 in addition to the rotation movement also carries out a translation movement away from the connection element 12. This translation movement is transmitted to the wings 16 and consequently the dispensing unit 10 so that it is also moved in a translational manner without moving in a rotational manner. This is shown in FIG. 7.

The translation movement of the closure element 11 brought about by the rotation of the closure element 11 (and associated translation movement of the wing element 16 or the dispensing unit 10) ends as soon as the projection 26 has reached an end of the inclined introduction member 19 (this is shown in FIG. 8). In this state, the retention forces applied by the application device main body (or a shoulder element of the application device) are (substantially) overcome so that the dispensing unit 10 can be completely removed without great application of force and in a simple manner (by the operator). On the whole, the significant components of the lifting device are the elements 25, 26 and 19. These elements force the wings 16 of the dispensing unit 10 upward or lift these wings 16.

The bayonet closure is in particular produced by means of the inclined introduction member 24 and the rib 25 (which together can form an integral component) together with the pin 18. If the FIGS. 8 to 6 are considered in reverse, the operating method of this bayonet closure can be derived. In this instance, FIG. 8 shows the position which the dispensing unit and the closure element 11 assume at the beginning of the securing operation. If the closure element 11 is now rotated (in FIGS. 3 to 8 in a clockwise direction when viewed from above), the inclined introduction member 24 runs against the pin 18 and forces the closure element 11 (together with the dispensing unit 10 via an annular projection 27, which is in abutment against the dispensing unit 10) downward (see FIG. 7). Further rotation finally leads to the end position according to FIG. 6, in which the dispensing unit 10 is secured to the connection element 12 and consequently the application unit or the application device can be used.

As can be seen in particular in FIG. 3, the inclined introduction member 24, the rib 25 and the projection 26 are located on an inner peripheral face 28 of the closure element 11. As can be seen in particular in FIG. 4, the wings 16 are located on an outer peripheral face 29 of the dispensing unit 10. The wings 16 can thereby be brought into engagement with the rib 25 in a particularly simple manner. Furthermore, the inclined introduction member 24 can also cooperate with the pin 18 (as described above) in a particularly effective manner.

### LIST OF REFERENCE NUMERALS

10 Dispensing unit
11 Closure element
12 Connection element
13 Outer peripheral face
14 Projection
15 Cylindrical member
16 Wing
17 Recess
18 Pin
19 Inclined introduction member
20 Peripheral edge
21 Outer peripheral face
22 Mixer unit
23 Discharge nozzle
24 Inclined introduction member
25 Rib
26 Projection
27 Annular projection
28 Inner peripheral face
29 Outer peripheral face

1. An application unit for an application device for applying gel-like and/or paste-like compositions, comprising:
a dispensing unit for dispensing a composition;
a connection element for connecting the dispensing unit to an application device main body; and
a closure element, wherein the closure element is rotatable about a rotation axis with respect to the connection element and the dispensing unit in order to secure the dispensing unit to the connection element and to release the dispensing unit from the connection element, wherein a lifting device is constructed and arranged in such a manner that the dispensing unit will be lifted by rotating the closure element.

2. The application unit as claimed in claim 1, wherein the closure element and connection element form a bayonet closure in order to secure the dispensing unit to the connection element, wherein the lifting device is at least partially formed by the bayonet closure and wherein a common rib is a component of both the bayonet closure and the lifting device.

3. The application unit as claimed in claim 1, wherein the lifting device has a closure element stop and a dispensing unit stop, wherein the closure element stop and the dispensing unit stop, when the closure element is rotated, will come into sliding contact in such a manner that the dispensing unit will be lifted as a result of the rotation of closure element.

4. The application unit as claimed in claim 3, wherein the closure element stop is a component of the bayonet closure and/or wherein a surface normal of the closure element stop and/or the dispensing unit stop extends parallel to the rotation axis.

5. The application unit as claimed in claim 4, wherein the closure element stop is provided on an inner peripheral face of the closure element and/or the dispensing unit stop is provided on an outer peripheral face, of the dispensing unit.

6. The application unit as claimed in claim 3, wherein the closure element stop and/or the dispensing unit stop is/are defined by a side face of a rib and/or wherein the closure element stop and/or the dispensing unit stop is/are defined by a side face, on a lower side, of a wing element.

7. The application unit as claimed in claim 1, wherein the dispensing unit has at least one radially outwardly directed, wing element, and the connection element has a corresponding recess for receiving the wing element.

8. The application unit as claimed in claim 1, wherein the dispensing unit comprises:
a mixer unit and/or a nozzle element.

9. The application unit as claimed in claim 1, wherein the bayonet closure has an inclined introduction member which is formed on the closure element and which, when the dispensing unit is secured, runs against a pin of the connection element and/or wherein the bayonet closure has on the connection element an inclined connection element introduction member which, when the dispensing unit is secured, will run against a projection of the closure element.

10. The application unit as claimed in claim 1, wherein the closure element and connection element form a screw closure, comprising:
two mutually corresponding threads, in order to secure the dispensing unit to the connection element.

11. An application device, configured as an application gun for applying gel-like and/or paste-like compositions, comprising:
an application unit as claimed in claim 1.

12. A method for applying gel-like and/or paste-like compositions, comprising:
dispensing a composition from a dispending unit connected via a connection element to an application device main body;
rotating a closure element about a rotation axis with respect to the connection element and the dispensing unit to secure the dispensing unit to the connection element and to release the dispensing unit from the connection element; and
lifting the dispensing unit via a lifting device by rotating the closure element.
